(19) United States
(12) Patent Application Publication
(10) Pub. No.: US 2005/0056712 A1
(43) Pub. Date: Mar. 17, 2005

(54) Fuel injection valve

(75) Inventor: Norihisa Fukutomi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/782,774

(22) Filed: Feb. 23, 2004

(30) Foreign Application Priority Data
Sep. 11, 2003 (JP) 2003-320191

(51) Int. Cl. F02M 61/00

(52) U.S. Cl. 239/585.1; 239/533.12; 239/463

(57) ABSTRACT

A fuel injection valve of low collision noise includes a housing (3), a core (4) secured internally of the housing (3), an electromagnetic coil (5) disposed externally around the core (4), a valve body (13) secured to the housing (3), a rod-like valve element (9) disposed reciprocatively movably within the valve body (13), an armature (10) secured to the valve element (9) at one end and attracted to the core (4) upon energization of the electromagnetic coil (5), and a valve seat (11) disposed at one end of the valve body (13) and having a seat portion (11a) and a fuel injection port (11b). A variable gap (A) is formed between an end face of the armature (10) and that of the valve body (13) such that flow path area of the gap (A) diminishes as the valve element (9) moves toward the valve seat (11).

### BACKGROUND OF THE INVENTION

1. Field of the Invention

The present invention relates to a fuel injection valve for injecting a fuel to be charged into a cylinder of an internal combustion engine by actuating a valve element for opening an injection port of the valve.

2. Description of Related Art

In the conventional or hitherto known fuel injection valve of the type mentioned above, a gap (which may-also be termed clearance) formed between the outer peripheral surface of an armature and the inner peripheral space of a lower housing is made use of as a fuel flow constricting portion with a view to decelerating the valve element upon displacement thereof to a predetermined position to thereby suppress or reduce the noise generated when the valve element strikes against the valve seat. For more particulars, reference may have to be made to Japanese Patent Application Laid-Open Publication No. 189437/1996 (JP-A-1996-189437), FIG. 1.

The valve element of the fuel injection valve mentioned above is placed in the opened state when the armature contacts the end face of the core. The stroke or lift of the valve element is determined by adjusting finely the axial position of the valve body in which the valve element is slideably disposed relative to the lower housing.

In the conventional fuel injection valve, since the relative position between the armature and the lower housing is determined by the lift adjusting quantity of the valve element, as mentioned above, the relative position between the outer peripheral surface of the armature and the inner peripheral surface of the lower housing in the axial direction, which defines the fuel flow constricting portion, depends on the lift adjusting quantity of the valve element. In this conjunction, it is noted that the gap size of the fuel flow constricting portion provided in order to reduce the collision noise will vary from one to another product and thus the collision noise becomes nonuniform among the fuel injection valve products, giving rise to a problem that the products of low collision noise may not evenly be supplied to the users.

### SUMMARY OF THE INVENTION

In the light of the state of the art described above, it is an object of the present invention to solve the problem mentioned above by providing a fuel injection valve of an improved structure which is capable of reducing or suppressing the collision noise generated upon closing operation of the valve element as well as variance among the products.

In view of the above and other objects which will become apparent as the description proceeds, there is provided according to a general aspect of the present invention a fuel injection valve which includes a housing, a core secured internally of the housing, an electromagnetic coil disposed externally around the core, a valve body of a substantially cylindrical form secured to the housing, a rod-like valve element disposed to be reciprocatively movable within the valve body, an armature secured to the valve element at one end thereof and attracted to the core upon electric energization of the electromagnetic coil, and a valve seat disposed at one end of the valve body and having a seat portion against which other end face of the valve element bears and an injection port through which a fuel flows.

In the fuel injection valve mentioned above, a variable gap is formed between an end face of the armature and that of the valve body in such an arrangement that fuel flow path area of the variable gap is diminished as the valve element moves toward the valve seat.

With the structure of the fuel injection valve, it is possible to reduce collision noise generated upon closing of the valve element as well as variance thereof among the products.

The above and other objects, features and attendant advantages of the present invention will more easily be understood by reading the following description of the preferred embodiments thereof taken, only by way of example, in conjunction with the accompanying drawings.

### BRIEF DESCRIPTION OF THE DRAWINGS

In the course of the description which follows, reference is made to the drawings, in which:

FIG. 1 is a sectional view showing generally a structure of a fuel injection valve adapted to be mounted on a cylinder head of an engine cylinder according to a first embodiment of the present invention;

FIG. 2 is an enlarged view showing a major portion of the fuel injection valve shown in FIG. 1;

FIG. 3 is a sectional view taken along a line A-A shown in FIG. 1;

FIGS. 4A, 4B, 4C and 4D are views for illustrating a process of securing fixedly a valve seat to a valve body;

FIG. 5 is a view for graphically illustrating a displacement profile of a valve element of the fuel injection valve upon opening/closing operation thereof;

FIG. 6 is a view for graphically illustrating a relation between the displacement of the valve element and a flow path area of a variable gap;

FIG. 7 is a sectional view showing a major portion of the fuel injection valve according to a second embodiment of the present invention;

FIG. 8 is a sectional view showing a major portion of the fuel injection valve according to a third embodiment of the present invention; and

FIG. 9 is a sectional view showing a major portion of the fuel injection valve according to a fourth embodiment of the present invention.

### DESCRIPTION OF THE PREFERRED EMBODIMENTS

The present invention will be described in detail in conjunction with what is presently considered as preferred or typical embodiments thereof by reference to the drawings. In the following description, like reference characters designate like or equivalent parts, members and portions throughout the several views. Also in the following description, it is to be understood that such terms as “top”, “bottom”, “upper”, “lower” and the like are words of convenience and are not to be construed as limiting terms.

### Embodiment 1

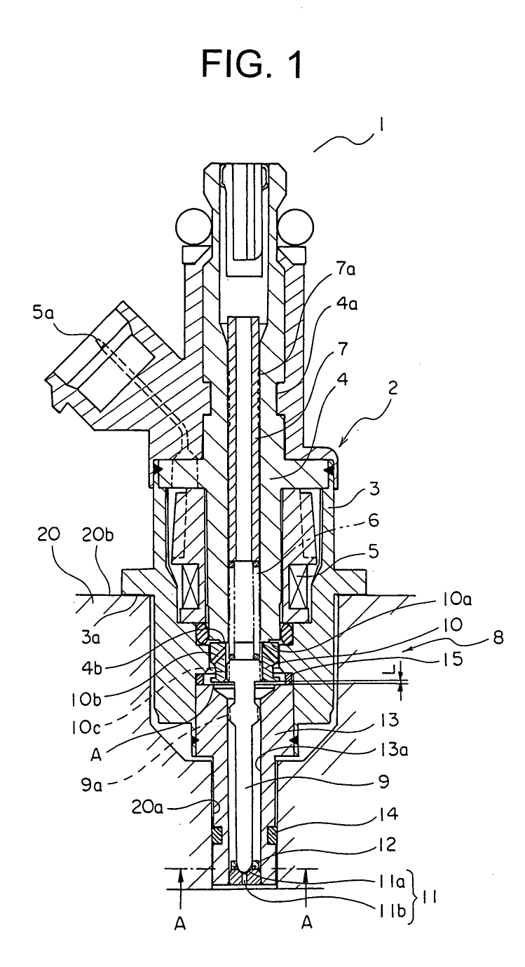

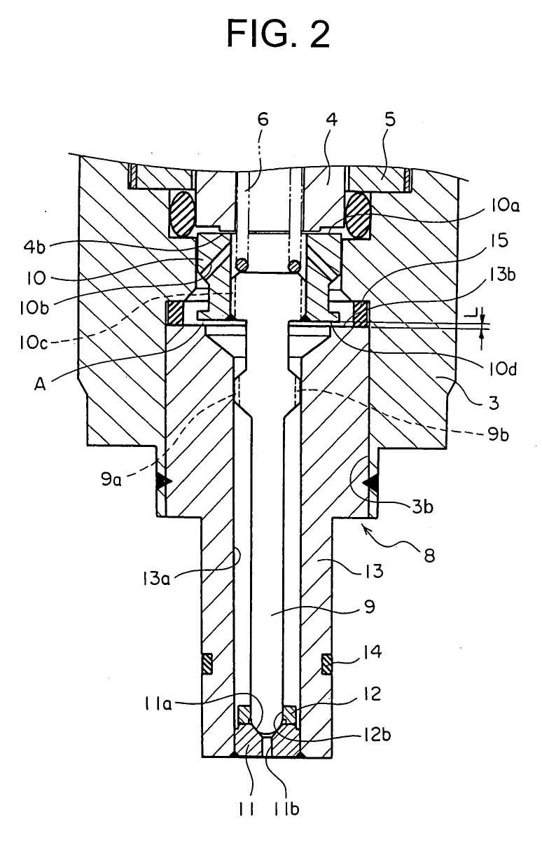

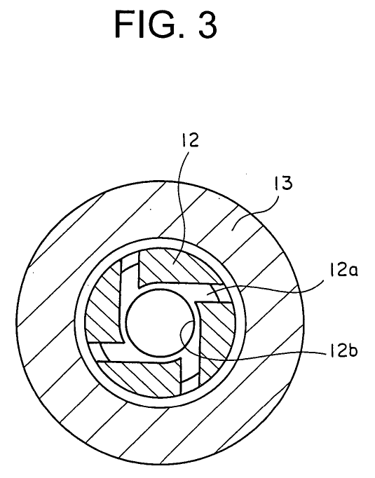

FIG. 1 is a sectional view showing generally a structure of the fuel injection valve 1 mounted on a cylinder head of an engine cylinder according to a first embodiment of the present invention, FIG. 2 is an enlarged view showing a major portion of the fuel injection valve shown in FIG. 1, and FIG. 3 is a sectional view taken along a line A-A shown in FIG. 1.

The fuel injection valve 1 has a tip end portion inserted into a hole 20a formed in a cylinder head 20 of an internal combustion engine with a seal member 14 being interposed therebetween and is fixedly secured by a securing means (not shown) with a flange lower surface 3a being disposed in contact with a top surface 20b of the cylinder head.

The fuel injection valve 1 is comprised of a solenoid device 2 and a valve unit 8 which is designed to be actuated upon electrical energization of the solenoid device 2.

The solenoid device 2 mentioned above is composed of a housing 3, a core 4 formed substantially in a cylindrical hollow column shape and fixedly disposed within the housing 3, being secured thereto by welding, an electromagnetic coil 5 disposed externally around the core 4, a rod 7 formed in a cylindrical hollow column shape and fixedly secured to an inner peripheral portion of the core 4, and a spring 6 disposed within a cylindrical inner space of the core 4 and having one end portion which bears against a bottom end face of the rod 7.

The rod 7 is inserted into the inner cylindrical space of the core 4 to a position at which the spring 6 is compressed to the extent ensuring the injection of fuel of a predetermined amount or quantity under the spring force or elasticity of the spring 6. This rod 7 is fixedly secured to the core 4 with an annular concavo-convex portion 7a formed in the outer peripheral surface of the rod 7 being caused to encroachingly mesh with the inner peripheral surface of the core 4 by pushing diametrically inwardly an intermediate portion 4a of the core 4.

On the other hand, the valve unit 8 mentioned above is composed of a valve body 13 of a cylindrical hollow column shape which is press-fit into a concave portion 3b formed in the bottom end portion of the housing 3 with a plate 15 being interposed therebetween and which is fixedly secured to the housing 3 by welding, a rod-like valve element 9 disposed slideably within the valve body 13, an armature 10 fixedly secured to the top end portion of the valve element 9 and having fuel passages 10b, a valve seat 11 fixedly secured to the bottom end portion of the valve body 13 by welding and having a seat portion 11a and an injection port 11b, and a swirler 12 secured by welding onto the upper portion of the valve seat 11 and provided with swirling passages 12a for swirling the fuel upon injection (see FIG. 3). At this juncture, it should be mentioned that the magnitude of displacement of the valve element 9 between the opening and closing positions (i.e., magnitude of the displacement of the armature 10 relative to the core 4 in the axial direction) is regulated or adjusted by selecting appropriately the thickness of the plate 15 mentioned above.

The valve element 9 has a diametrically protruding portion 9a which is placed in slideable contact with an inner wall surface 13a of the valve body 13. Further, the tip end portion of the valve element 9 can also slideably contact with an inner wall surface 12b of the swirler 12. The valve element 9 is limited with regard to one position thereof in the axial direction by the seat portion 11a of the valve seat 11 against which the valve element 9 is caused to bear down. On the other hand, the other position of the valve element 9 in the axial direction is delimited by a bottom end face 4b of the core 4 upon which the top end face 10a of the armature 10 secured to the valve element 9 is caused to bear.

The valve seat 11 is adjusted in respect to the position thereof upon being press-fit into the inner peripheral portion of the valve body 13 so that a clearance L between the top end face 13b of the valve body 13 and the bottom end face 10d of the armature 10 (FIG. 2) assumes a predetermined value. The valve seat 11 is fixedly secured to the bottom end face of the valve body 13 by welding after the positional adjustment.

More specifically, the clearance L is defined between the top end face 13b of the valve body 13 and the bottom end face 10d of the armature 10 when the valve element 9 is closed, and the size of the clearance L is determined by the position of the valve seat 11 fixedly secured to the valve body 13.

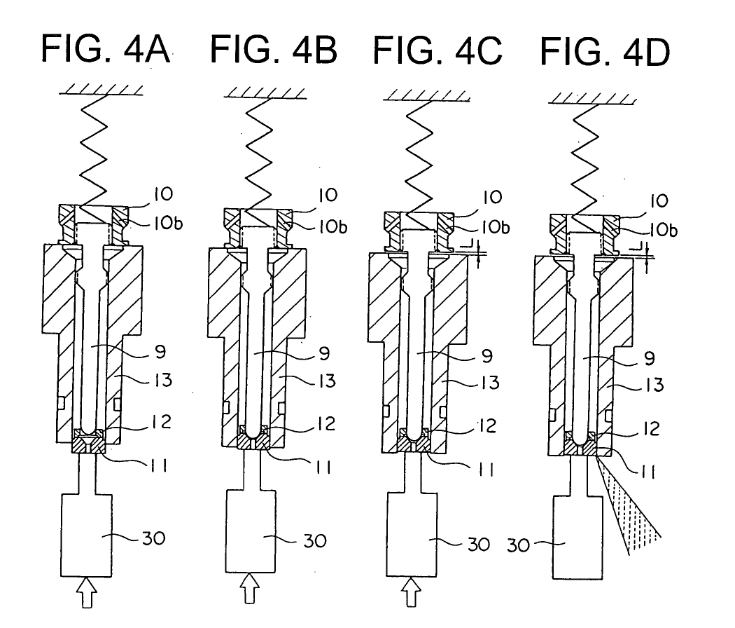

FIGS. 4A to 4D are views for illustrating a process of adjustably setting the clearance L.

Referring to these figures, the valve element 9 integrally coupled to the armature 10 by welding is firstly inserted into the cylindrical inner space of the valve body 13 from the top side thereof. Subsequently, the valve seat 11 integrally coupled with the swirler 12 by welding is inserted into the valve body 13 with the aid of a pushing member 30 from the bottom side of the valve body and pushed upwardly together with the valve element 9 (see FIGS. 4A and 4B). Thereafter, the pushing operation of the pushing member 30 is stopped when the relative position in the axial direction between the valve body 13 and the valve element 9 pushed upwardly delimits the clearance L (see FIG. 4C). Finally, the valve seat 11 is fixedly secured to the valve body 13 by laser welding, as indicated in phantom in FIG. 4D.

Next, description will be directed to the operation of the fuel injection valve 1 of the structure described above.

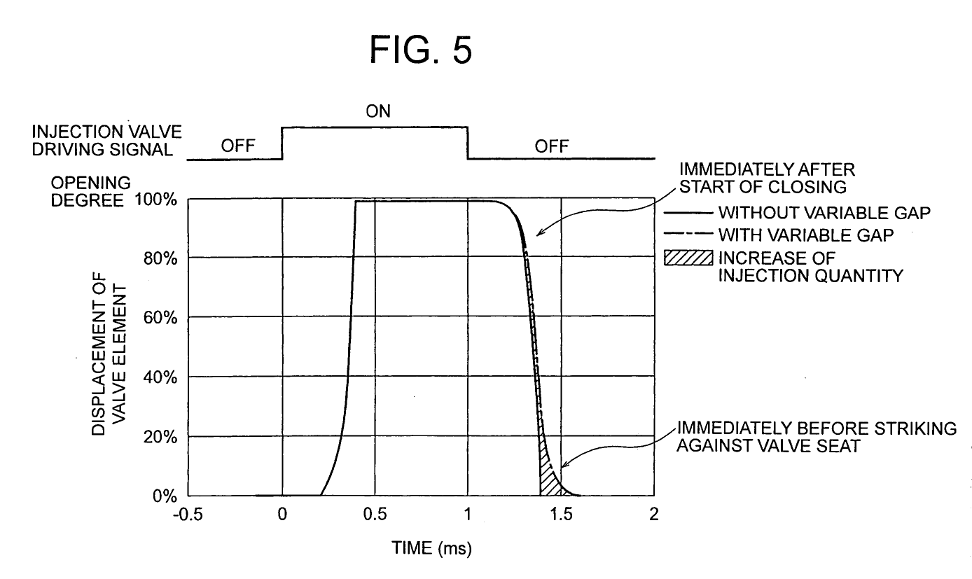

When an actuation or drive signal of “ON” level (see FIG. 5) is supplied to a driving circuit (not shown) for the fuel injection valve 1 from a microcomputer constituting a major part of the control apparatus for the internal combustion engine (not shown either), an electric current flows through the electromagnetic coil 5 of the fuel injection valve 1 from a terminal 5a, which results in that magnetic flux is generated in a magnetic circuit constituted through cooperation of the housing 3, the core 4 and the armature 10. As a result of this, the armature 10 which is constantly urged in the direction away from the core 4 under the elasticity of the spring 6 is magnetically attracted toward the core 4 against the spring force of the spring 6.

The valve element 9 structured integrally with the armature 10 is thus caused to move away from the seat portion 11a of the valve seat 11 with a gap being formed between the valve element 9 and the seat portion 11a, whereby the fuel is injected into the engine cylinder from the injection port 11b at a high fuel pressure of 1 MPa or more.

The valve opening position of the valve element 9 is determined by the top end face 10a of the armature 10 which bears against the bottom end face 4b of the core 4. Incidentally, the time duration of the fuel injection lies within a range of several tenths of a millisecond to several milliseconds.

When the valve element 9 is set to the opened state in response to the drive signal of “ON” level, as mentioned previously, the fuel flows into the inner cylindrical space of the rod 7 from a fuel supply pipe (not shown) and thence into the outer peripheral space of the armature 10 primarily through the passages 10b of the armature 10. Thereafter, the fuel enters the inner hollow space of the valve body 13 through a variable gap A defined by the clearance L between the bottom end face 10d of the armature 10 and the top end face 13b of the valve body 13 to flow downwardly. Further, a part of the fuel flows through the longitudinally extending slit portions 10c formed between the inner peripheral surface of the armature 10 and the valve element 9 into the inner hollow space of the valve body 13 to flow downward. In this conjunction, it should be added that axially extending slits 9b are formed in the sliding portion 9a of the valve element 9 with equi-distance therebetween so that the fuel flows downwardly through these slits 9b in the sliding portion 9a.

Subsequently, the fuel flows toward the center of the swirler 12 from the outer peripheral space thereof through the swirling passages 12a formed eccentrically relative to the axis of the fuel injection valve 1 to reach the seat portion 11a of the valve seat 11 to be finally injected into the engine cylinder through the injection port 11b.

After the fuel injection of several tenths of a millisecond to several milliseconds, electrical energization of the electromagnetic coil 5 is terminated in response to the signal of “OFF” level supplied from the microcomputer of the engine control apparatus. Thus, the electromagnetic force makes disappearance. As a result of this, the valve element 9 is pushed downwardly toward the valve seat 11 under the action of elasticity of the spring 6 till the tip end portion of the valve element 9 strikes against the seat portion 11a, whereupon the fuel injection is interrupted after the time lapse of several tenths of a millisecond or so from the start of fuel injection.

At the time point the valve element 9 strikes against the seat portion 11a of the valve seat 11 in the closing operation of the valve element 9, a major portion of the kinetic energy of the valve element 9 is transformed into vibration energy of the valve element 9 and the valve seat 11. The vibration energy of the valve seat 11 is transmitted sequentially through the valve body 13, the housing 3 and the cylinder head 20 to be radiated in the form of noise externally of the motor vehicle equipped with the engine concerned.

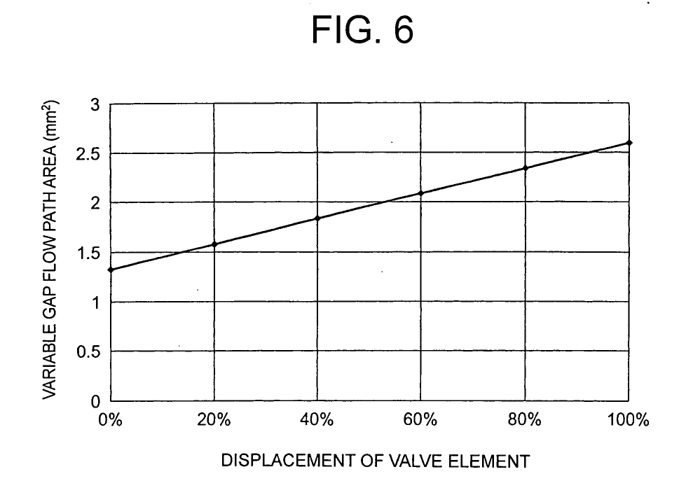

FIG. 5 is a view for graphically illustrating a displacement profile of the valve element 9 of the fuel injection valve in the opening/closing operation thereof together with the driving signal for the injection valve, and FIG. 6 is a view for graphically illustrating a relation between the displacement of the valve element 9 and the flow path area of the variable gap A.

In the closing operation of the fuel injection valve with the valve element 9 being forced to move downwardly, the flow path area between the tip end surface of the valve element 9 and the seat portion 11a of the valve seat 11 remains large immediately after the closing movement of the valve element 9 has been started. Consequently, in the initial phase of the valve closing operation, the static pressure prevailing upstream of the variable gap (variable flow constricting portion, to say in anther way) A is hither than that prevailing downstream of the variable gap A, exerting less influence to the deceleration of closing movement of the valve element 9.

However, as the ring-like flow path area defined between the tip end face of the valve element 9 and the seat portion 11a becomes narrower in accompanying the downward displacement of the valve element 9, the static pressure of the fuel prevailing in the vicinity of the valve seat 11 increases due to the inertial action of the fuel, as a result of which the static pressure prevailing downstream of the variable gap or flow constricting portion A becomes higher than that prevailing upstream of the variable gap A. As a consequence, there makes appearance across the variable gap A a fuel pressure difference of the direction or sign opposite to that of the pressure difference occurring immediately after the start of the valve closing operation. Hereinafter, this phenomenon will also be referred to as the blocking effect only for the convenience of description. Because the fuel flow path area of the variable gap A gradually decreases as the valve element 9 displaces downwardly, the pressure difference (absolute value) appearing across the variable gap A and hence the blocking effect increases progressively. Thus, owing to the blocking effect which becomes more and more effective as the valve element 9 moves downwardly, the downward movement of the valve element 9 is decelerated under the influence of the force which tends to push upwardly the valve element 9, and the maximum deceleration becomes effective immediately before the valve element 9 strikes against the valve seat 11.

In this conjunction, it should be noted that even though the response of the valve element 9 in the valve closing operation is accompanied with a delay more or less, increase of the fuel injection quantity due to the delay of response of the valve element 9 can be suppressed to a minimum, as can be seen from the displacement profile of the valve element 9 illustrated in FIG. 5. By way of example, in the idle operation of the internal combustion engine, fuel injection of a small amount is required. In this conjunction, it is noted that since the increase of the fuel injection quantity is suppressed, as mentioned above, the collision noise can be damped or decreased without being accompanied with any appreciable degradation of the engine performance controllability.

As can be appreciated from the foregoing, with the structure of the fuel injection valve according to the first embodiment of the invention, the closing movement of the valve element 9 is decelerated and thus the collision noise generated upon striking of the valve element 9 against the valve seat 11 can significantly be reduced or damped by virtue of such arrangement that the variable gap A of the ring-like shape is formed between the bottom end face 10d of the armature 10 and the top end face 13b of the valve body 13, to a great advantage.

Furthermore, since adjustment of the clearance L defining the variable gap A can be realized by adjusting the position of the valve seat 11 secured to the valve body 13, a high accuracy can be ensured for the dimension of the variable gap A. Owing to this feature, not only the collision noise generated in the closing operation of the valve element 9 can be reduced but also dispersion of magnitude of the collision noise among the products can be minimized, to another advantage.

### Embodiment 2

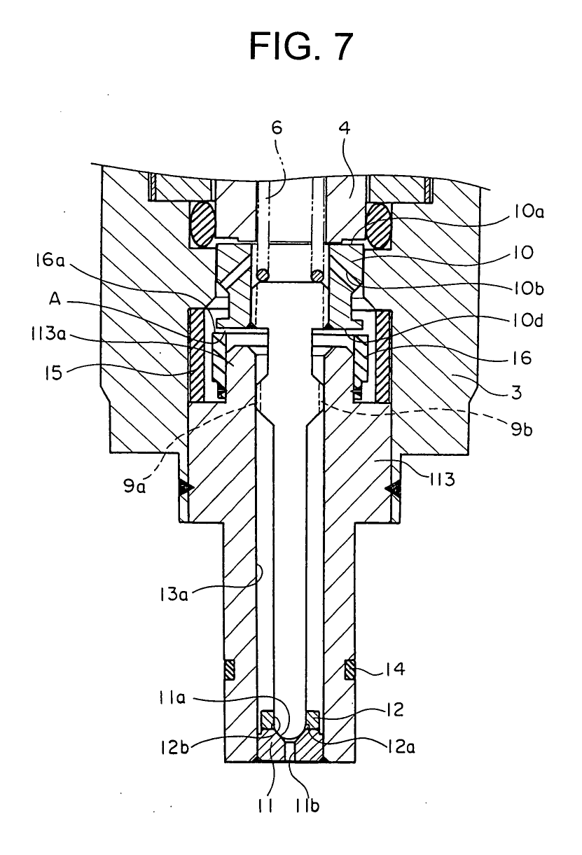

FIG. 7 is a sectional view showing a major portion of the fuel injection valve 1 according to a second embodiment of the present invention.

In the case of the fuel injection valve 1 now under consideration, the valve body designated by reference numeral 113 is formed with a column-like projecting portion 113a at a top portion thereof. Further, a column-like sleeve 16 is bonded to the outer peripheral surface of the projecting portion 113a by welding, wherein the variable gap A is formed between the top end face 16a of the sleeve 16 and the bottom end face 10d of the armature 10. Except for the differences mentioned above, the structure of the fuel injection valve according to the second embodiment of the invention is essentially similar to that of the first embodiment.

With the structure of the fuel injection valve 1 according to the second embodiment of the invention, the size or dimension of the variable gap A can adjustably be set without any appreciable difficulty by adjusting the mounting position of the sleeve 16 relative to the projecting portion 113a in the axial direction. Thus, when compared with fuel injection valve according to the first embodiment of the invention, adjustment of the size of the variable gap (fuel flow constricting portion) A can be simplified, whereby the assembling work efficiency can be enhanced, to an advantage.

### Embodiment 3

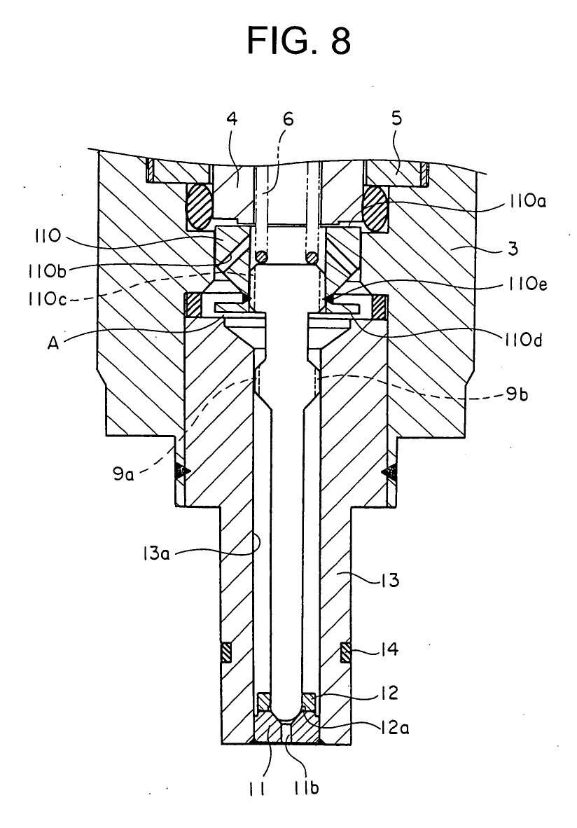

FIG. 8 is a sectional view showing a major portion of the fuel injection valve 1 according to a third embodiment of the present invention.

In the case of the fuel injection valves according to the first and second embodiments of the invention, the sliding portion 9a of the valve element 9 is disposed slideably in contact with the inner wall surface 13a of the valve body 13, which naturally requires that the valve body 13 be made of a material of high hardness in order to assure a wear-resistance. To this end, martensitic iron material, e.g. SUS440, is used. For this reason, upon electric energization of the electromagnetic coil 5, magnetic leakage takes place in the direction toward the valve body 13; 113 by way of the variable gap A in addition to generation of the flux in the magnetic circuit formed through cooperation of by the housing 3, the core 4 and the armature 10.

To cope with this problem, in the fuel injection valve according to the third embodiment of the invention, a thin portion 110e is formed in the outer peripheral surface of the armature 110. Owing to this arrangement, the flux path area is decreased at this portion or location, as a result of which the magnetic leakage to the valve body 13 through the variable gap A can be reduced. Parenthetically, thickness size of this portion may preferably be, for example, about 0.4 mm at minimum in view of the mechanical strength as demanded.

It should further be added that since the armature 110 and the valve element 9 are integrally combined at the thin portion 110e by welding, the magnetic property of the thin portion 110e can be rendered less effective at a high temperature, whereby the magnetic reluctance of this portion increases correspondingly, which contributes to further suppression of the magnetic leakage.

Parenthetically, in FIG. 8, reference character 110a denotes the top end face of the armature 110, 110b denotes a fuel passage, 110c denotes slits and 110d denotes a bottom end face.

With the structure of the fuel injection valve 1 according to the third embodiment of the invention described above, the magnetic leakage by way of the variable gap A can further be decreased, whereby the electromagnetic attracting force acting between the core 4 and the armature 110 is protected from lowering. This in turn means that the power consumption of the fuel injection valve 1 can be reduced, to an advantage.

### Embodiment 4

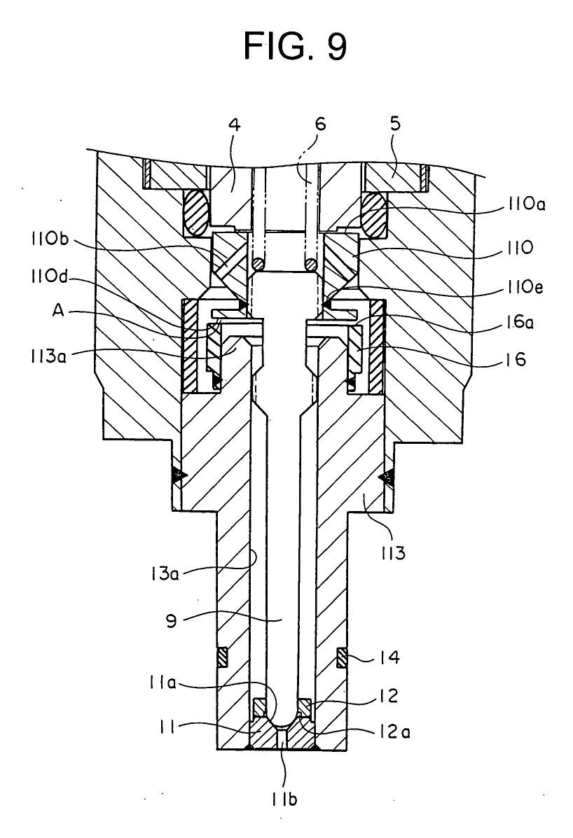

FIG. 9 is a sectional view showing a major portion of the fuel injection valve 1 according to a fourth embodiment of the present invention.

In the case of the fuel injection valve according to the instant embodiment of the invention, the sleeve 16 is secured to the projecting portion 113a of the valve body 113 while the armature 110 is formed with a thin portion 110e. The armature 110 is fixedly secured to the valve element 9 at this thin portion 10e by welding.

Owing to the structure of the fuel injection valve 1 according to the instant embodiment of the invention, the size or dimension of the variable gap A can easily be set by adjusting the mounting position of the sleeve 16 relative to the projecting portion 113a in the axial direction.

Further, because the armature 110 is formed with the thin portion 110e, the magnetic reluctance of this thin portion 110e increases, whereby the magnetic leakage to the sleeve 16 through the variable gap A can be decreased. As a result of this, the electromagnetic attracting force acting between the core 4 and the armature 110 is protected from lowering. This in turn means that the power consumption of the fuel injection valve 1 can be saved.

Many features and advantages of the present invention are apparent from the detailed description and thus it is intended by the appended claims to cover all such features and advantages of the fuel injection valve which fall within the spirit and scope of the invention. Further, since numerous modifications and changes will readily occur to those skilled in the art, it is not desired to limit the invention to the exact construction and operation illustrated and described.

By way of example, in the foregoing description of the exemplary embodiments of the invention, it has been assumed that the present invention is applied to the cylinder injection type fuel injection valve. However, it goes without saying that the invention can equally be applied not only to the fuel injection valve destined to be mounted on the intake pipe or manifold of the engine but also to the fuel injection valve which is not provided with the swirler.

Additionally, although it has been assumed that the valve body 13 and the valve seat 11 are implemented as the separate members, the invention can find application to the fuel injection valve in which the valve seat having the injection port is integrally formed at the tip end portion of the valve body.

Accordingly, all suitable modifications and equivalents may be resorted to, falling within the scope of the invention.

1. A fuel injection valve, comprising:
a housing;
a core secured internally of said housing;
an electromagnetic coil disposed externally around said core,
a valve body of a substantially cylindrical form secured to said housing;
a rod-like valve element disposed to be reciprocatively movable within said valve body;
an armature secured to said valve element at one end thereof and attracted to said core upon electric energization of said electromagnetic coil; and
a valve seat disposed at one end of said valve body and having a seat portion against which other end face of said valve element bears and an injection port through which a fuel flows,
wherein a variable gap is formed between an end face of said armature and that of said valve body in such an arrangement that fuel flow path area of said variable gap is diminished as said valve element moves toward said valve seat.

2. A fuel injection valve, comprising:
a housing;
a core secured internally of said housing;
an electromagnetic coil disposed externally around said core,
a valve body of a substantially cylindrical form secured to said housing;
a rod-like valve element disposed to be reciprocatively movable within said valve body;
an armature secured to said valve element at one end thereof and attracted to said core upon electric energization of said electromagnetic coil;
a cylindrical sleeve secured to said valve body at one end thereof on the side of said armature and projecting toward said armature; and
a valve seat disposed at other end of said valve body and having a seat portion against which other end face of said valve element bears and an injection port through which a fuel flows,
wherein a variable gap is formed between an end face of said armature and that of said sleeve in such a manner that fuel flow path area of said variable gap is diminished as said valve element moves toward said seat portion.

3. A fuel injection valve according to claim 1,
wherein a thin portion is formed in an outer peripheral portion of said armature for diminishing a magnetic flux path area.

4. A fuel injection valve according to claim 3,
wherein said armature is fixedly secured to said valve element at said thin portion by welding.
